(19) United States
(12) Patent Application Publication
(10) Pub. No.: US 2026/0183937 A1
(43) Pub. Date: Jul. 2, 2026

(54) ARTICULATED ROBOT

(71) Applicants: Samsung Display Co., LTD., Yongin-si (KR); Bontech co,.LTD, Asan-si (KR)

(72) Inventors: Min Su KIM, Yongin-si (KR); Suk KI, Yongin-si (KR); Chang Nam KIM, Asan-si (KR)

(21) Appl. No.: 19/076,197

(22) Filed: Mar. 11, 2025

(30) Foreign Application Priority Data
Jul. 12, 2024 (KR) 10-2024-0092689

(51) Int. Cl. B25J 9/10; B25J 17/00; B25J 19/02

(52) U.S. Cl. CPC B25J 9/101; B25J 17/00; B25J 19/021

(57) ABSTRACT

An articulated robot may include: a first rotating part; a second rotating part rotatably connected to the first rotating part; a connector connecting the first rotating part and the second rotating part, where a first connector hole and a second connector hole are defined in the connector; and a stopper including a portion detachably inserted into each of the first connector hole and the second connector hole. The stopper includes: a main body including the portion inserted into each of the first connector hole and the second connector hole; a support disposed under the main body, where a support hole is defined in the support; and a fastener including a portion detachably inserted into the support hole.

This application claims priority to Korean Patent Application No. 10-2024-0092689, filed on Jul. 12, 2024, all the benefits accruing therefrom under 35 U.S.C. § 119, the content of which in its entirety is herein incorporated by reference.

### BACKGROUND

### (1)Field of Invention

Various embodiments of the disclosure relate to an articulated robot.

### (2)Description of Related Art

Articulated robots are provided with joints similar to those in the human body, such as shoulders, arms, and wrists, to implement operations similar to human movements, and are widely used as assembly/painting/welding robots in factory production lines because the articulated robots can accurately implement desired operations and have a high degree of freedom in movement relative to installation spaces.

The articulated robots may include a plurality of rotating parts, and stoppers capable of adjusting movement ranges of the rotating parts.

### SUMMARY

An embodiment of the disclosure is directed to an articulated robot in which a stopper can be easily attached and detached to allow a position of the stopper to be easily adjusted, thereby enabling adjustment in rotational radius of a rotating part.

An embodiment of the disclosure is directed to an articulated robot in which the position of the stopper can be easily adjusted without disassembling the robot.

An embodiment of the disclosure provides an articulated robot, including: a first rotating part; a second rotating part rotatably connected to the first rotating part; a connector connecting the first rotating part and the second rotating part, where a first connector hole and a second connector hole are defined in the connector; and a stopper including a portion detachably inserted into each of the first connector hole and the second connector hole. In such an embodiment, the stopper includes: a main body including the portion inserted into each of the first connector hole and the second connector hole; a support disposed under the main body, where a support hole is defined in the support; and a fastener including a portion detachably inserted into the support hole.

In an embodiment, the stopper may be in a first state in which the main body does not protrude further than an upper surface of the connector or in a second state in which the main body protrudes further in a first direction than the upper surface of the connector.

In an embodiment, the main body may include: a first body part positioned on a first end; a second body part positioned on a second end; and a third body part positioned between the first body part and the second body part. In such an embodiment, the third body part may have a first shape.

In an embodiment, each of the first connector hole and the second connector hole may have a second shape corresponding to the first shape. In such an embodiment, the third body part may be detachably fastened into each of the first connector hole and the second connector hole.

In an embodiment, each of the first shape and the second shape may correspond to a threaded shape.

In an embodiment, the main body may include a body hole. In such an embodiment, the fastener may have at least a portion detachably inserted into the body hole.

In an embodiment, the support may have an outer diameter greater than an outer diameter of the main body, in a plan view.

In an embodiment, the fastener may include a first fastening part and a second fastening part. In such an embodiment, the first fastening part may have an outer diameter less than an outer diameter of the second fastening part, in a plan view. In such an embodiment, the second fastening part may not be inserted into the support hole.

In an embodiment, the main body may move along an inner surface of each of the first connector hole and the second connector hole when a pressure or an electrical signal is applied thereto.

In an embodiment, the stopper may further include a movable part disposed adjacent to the main body. In such an embodiment, the movable part may include at least one selected from a spring, a cylinder, and a worm gear.

In an embodiment, the articulated robot may further include an optical sensor disposed over or under the stopper. In such an embodiment, the optical sensor may sense a movement of the stopper.

An embodiment of the disclosure provides an articulated robot, including: a first rotating part; a second rotating part rotatably connected to the first rotating part; a connector connecting the first rotating part and the second rotating part, where a first connector hole and a second connector hole are defined in the connector; and a stopper including a portion detachably inserted into each of the first connector hole and the second connector hole. In such an embodiment, the stopper includes a main body including the portion inserted into each of the first connector hole and the second connector hole. In such an embodiment, the stopper is in a first state in which the main body does not protrude further than an upper surface of the connector or in a second state in which the main body protrudes further in a first direction than the upper surface of the connector.

In an embodiment, the main body may include: a first body part positioned on a first end; a second body part positioned on a second end; a third body part positioned between the first body part and the second body part. In such an embodiment, the third body part may have a first shape.

In an embodiment, the first direction may correspond to a direction perpendicular to a plane on which the articulated robot is disposed. In such an embodiment, each of the first connector hole and the second connector hole may have a second shape corresponding to the first shape. In such an embodiment, the third body part may be detachably fastened into each of the first connector hole and the second connector hole.

In an embodiment, the third body part may include a portion inserted into the first connector hole or the second connector hole in each of the first state and the second state. In such an embodiment, a surface area with which the third body part in the second state contacts each of the first connector hole and the second connector hole may be greater than a surface area with which the third body part in the first state contacts each of the first connector hole and the second connector hole.

In an embodiment, the main body may move along an inner surface of each of the first connector hole and the second connector hole when a pressure or an electrical signal is applied thereto.

In an embodiment, the stopper may further include a movable part disposed adjacent to the main body. In such an embodiment, the movable part may include at least one selected from a spring, a cylinder, and a worm gear.

In an embodiment, the stopper may further include a support disposed under the main body, where a support hole may be defined in the support. In such an embodiment, the support may have an outer diameter greater than an outer diameter of the main body, in a plan view. In such an embodiment, the main body may be inserted into the first connector hole and the second connector hole until the support contacts the connector.

In an embodiment, the stopper may further include a fastener having at least a portion detachably inserted into the support hole. In such an embodiment, the fastener may include a first fastening part and a second fastening part. In such an embodiment, the first fastening part may have an outer diameter less than an outer diameter of the second fastening part, in a plan view. In such an embodiment, the second fastening part may not be inserted into the support hole.

In an embodiment, the articulated robot may further include an optical sensor disposed over or under the stopper. In such an embodiment, the optical sensor may sense a movement of the stopper.

### BRIEF DESCRIPTION OF THE DRAWINGS

FIG. 1 is a schematic sectional view of an articulated robot in accordance with an embodiment.

FIG. 2 is a schematic plan view illustrating rotating parts in accordance with an embodiment.

FIG. 3 is a schematic sectional view of a connector in accordance with an embodiment.

FIG. 4 is a schematic perspective view illustrating a stopper in accordance with an embodiment.

FIG. 5 is a schematic sectional view of a main body of the stopper in accordance with an embodiment.

FIG. 6 is a schematic perspective view showing insertion of the stopper into a first connector hole in accordance with an embodiment.

FIG. 7 is a schematic sectional view illustrating a first state and a second state of a stopper in accordance with an embodiment.

FIG. 8 is a schematic sectional view illustrating the first state and the second state of a stopper in accordance with an embodiment.

FIG. 9 is a schematic sectional view illustrating the first state and the second state of a stopper in accordance with an embodiment.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

It will be understood that when an element is referred to as being “on” another element, it can be directly on the other element or intervening elements may be present therebetween. In contrast, when an element is referred to as being “directly on” another element, there are no intervening elements present. In addition, when it is expressed that a first part such as a layer, a film, a region, or a plate is formed on a second part, the surface of the second part on which the first part is formed is not limited to an upper surface of the second part but may include other surfaces such as a side surface or a lower surface of the second part. To the contrary, in case that a first part such as a layer, a film, a region, or a plate is under a second part, the first part may be not only directly under the second part but a third part may intervene between them.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, the articulated robot in accordance with embodiments of the disclosure will be described in detail with reference to the accompanying drawings.

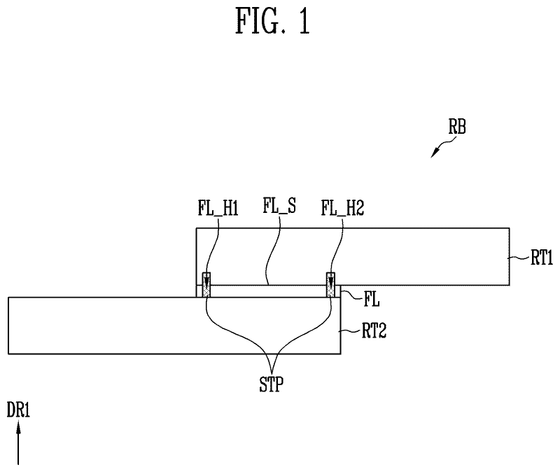

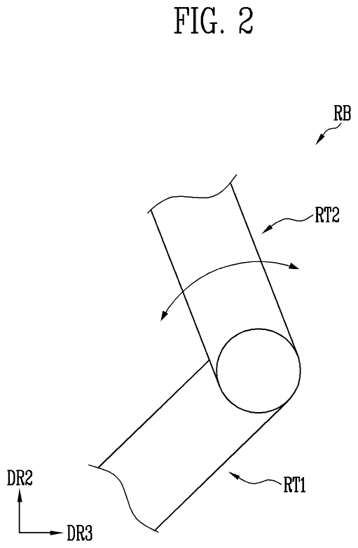

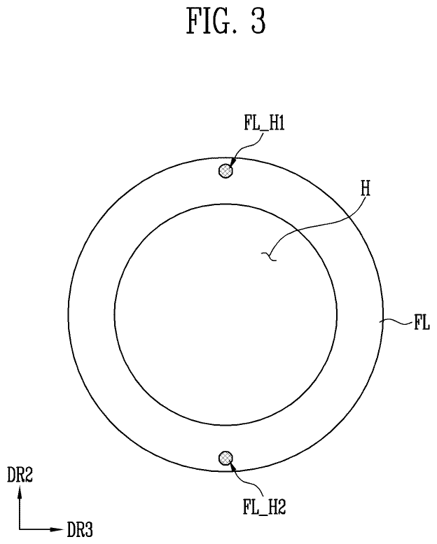

FIG. 1 is a schematic sectional view of an articulated robot in accordance with an embodiment. FIG. 2 is a schematic plan view illustrating rotating parts in accordance with an embodiment. FIG. 3 is a schematic sectional view of a connector in accordance with an embodiment.

Referring to FIGS. 1 to 3, an embodiment of an articulated robot RB may include a first rotating part RT1, a second rotating part RT2, a connector FL, and a stopper STP. In an embodiment, as illustrated in FIGS. 1 to 3, the articulated robot RB includes the two rotating parts RT1 and RT2, but the disclosure is not limited thereto. The number and lengths of rotating parts that form the articulated robot RB may be determined or variously modified according to the design. In an embodiment, for example, the articulated robot RB may include three or more rotating parts.

Each of the first rotating part RT1 and the second rotating part RT2 is rotatable. The rotating part RT2 may be installed to be rotatable relative to (or rotatably connected to) the first rotating part RT1. In an embodiment, each of the first rotating part RT1 and the second rotating part RT2 may be a robot arm of the articulated robot RB. Here, the disclosure is not limited to the aforementioned example. In an embodiment, at least one selected from the first rotating part RT1 and the second rotating part RT2 may be a driver including a driving source (e.g., a driving motor) of the articulated robot RB.

The connector FL may connect the first rotating part RT1 and the second rotating part RT2. In an embodiment, for example, the connector FL may connect the first rotating part RT1 and the second rotating part RT2 to each other in a way such that the second rotating part RT2 is rotatable with respect to the first rotating part RT1. The connector FL may be a joint of the articulated robot RB.

The connector FL may be provided with an opening H defined in a central portion thereof. In an embodiment, for example, the connector FL may have a ring shape with the opening H in the central portion thereof. In an embodiment, for example, the connector FL may be a flange with the opening H in the central portion thereof. However, the disclosure is not limited to the aforementioned example. Various configurations may be applied to the connector FL, and the connector FL may have various shapes.

In an embodiment, as shown in FIG. 3, the connector FL may be provided with a first connector hole FL_H1 and a second connector hole FL_H2. The number of holes formed in the connector FL may be determined or variously modified according to the design. The first connector hole FL_H1 and the second connector hole FL_H2 may be defined or formed through the connector FL.

The first connector hole FL_H1 and the second connector hole FL_H2 may be defined in a position near an edge of the connector FL. In an embodiment, for example, the first connector hole FL_H1 and the second connector hole FL_H2 may be defined at positions spaced apart from the edge of the connector FL by a certain distance.

In an embodiment, the first connector hole FL_H1 and the second connector hole FL_H2 may be spaced apart from a corresponding edge of the connector FL by a same distance. In an embodiment, a minimum distance between the first connector hole FL_H1 and the edge of the connector FL and a minimum distance between the second connector hole FL_H2 and the edge of the connector FL may be substantially the same as each other. In an embodiment, for example, the first connector hole FL_H1 and the second connector hole FL_H2 may be defined on a same circumference. In another embodiment, the first connector hole FL_H1 and the second connector hole FL_H2 may be spaced apart from the edge of the connector FL by different distances. In an embodiment, for example, the first connector hole FL_H1 and the second connector hole FL_H2 may be defined on different circumferences, respectively. In an embodiment, for example, the minimum distance between the first connector hole FL_H1 and the edge of the connector FL may be greater than the minimum distance between the second connector hole FL_H2 and the edge of the connector FL. Alternatively, the minimum distance between the first connector hole FL_H1 and the edge of the connector FL may be less than the minimum distance between the second connector hole FL_H2 and the edge of the connector FL.

At least a portion of the stopper STP may be inserted into the first connector hole FL_H1 and/or a second connector hole FL_H2. The stopper STP may be detachable from the first connector hole FL_H1 and/or a second connector hole FL_H2. That is, at least a portion of the stopper STP may be detachably inserted into the first connector hole FL_H1 and/or a second connector hole FL_H2.

The stopper STP may adjust (or limit) a rotational range of the first rotating part RT1 and the second rotating part RT2. In an embodiment, for example, the first rotating part RT1 and the second rotating part RT2 may come into contact with the stopper STP during rotation. The stopper STP may mechanically stop the first rotating part RT1 and the second rotating part RT2 from rotating beyond the rotational range.

A target for rotational range adjustment by the stopper STP is not limited to a specific example. However, for convenience, the following descriptions will be based on an example in which the stopper STP adjusts the rotational range of the first rotating part RT1.

The stopper STP may include a portion, a height of which with respect to an upper surface FL_S of the connector FL is adjusted depending on usage conditions thereof. Hereinafter, the height may be defined in a first direction DR1. The first direction DR1 may be defined as a direction perpendicular to a plane on which the second rotating part RT2 rotates (e.g., a plane extending in a second direction DR2 and a third direction DR3). The first direction DR1 may be a longitudinal direction thereof or a direction in which the stopper STP is inserted into the first connector hole FL_H1 and the second connector hole FL_H2.

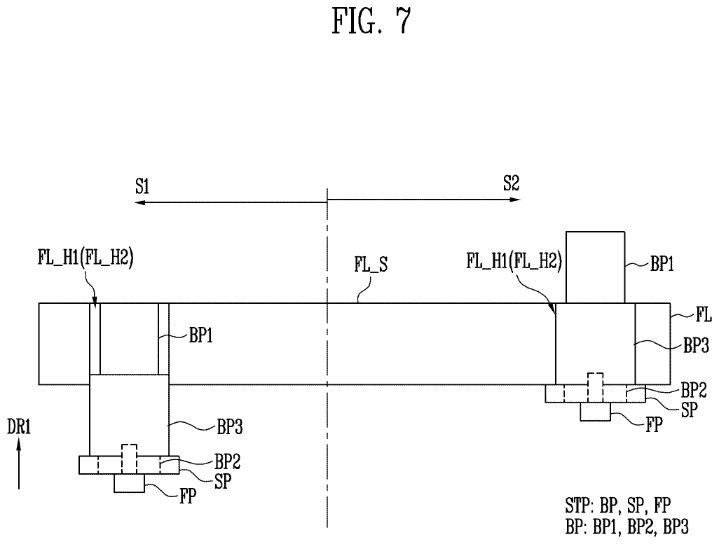

For example, in the case where all of the stoppers STP inserted into the first connector hole FL_H1 and the second connector hole FL_H2 are to be used, the stoppers STP may be inserted into the first connector hole FL_H1 and the second connector hole FL_H2 so as to protrude further in the first direction DR1 than the upper surface FL_S of the connector FL. In the case where only the stopper STP inserted into the first connector hole FL_H1 is to be used, the first stopper STP inserted into the first connector hole FL_H1 may protrude further in the first direction DR1 than the upper surface FL_S of the connector FL, while the stopper STP inserted into the second connector hole FL_H2 may not protrude further than the upper surface FL_S of the connector FL. A state in which no portion of the stopper STP protrudes further than the upper surface FL_S of the connector FL may be defined as a first state S1 (refer to FIG. 7). A state in which at least portion of the stopper STP protrudes further than the upper surface FL_S of the connector FL in the first direction may be defined as a second state S2 (refer to FIG. 7). Each of the stoppers STP may be positioned in one of the first state S1 and the second state S2. The state of the stopper STP may be adjusted or determined depending on a desired rotational radius and a desired rotation range of the first rotating part RT1.

According to an embodiment of the articulated robot RB of the disclosure, the operation of attaching or detaching the stopper STP may be facilitated, and the position of the stopper STP may be easily adjusted without additional modification (or disassembly) of the articulated robot RB. As a result, the rotational radius and the rotational range of the rotating parts RT1 and RT2 may be easily adjusted.

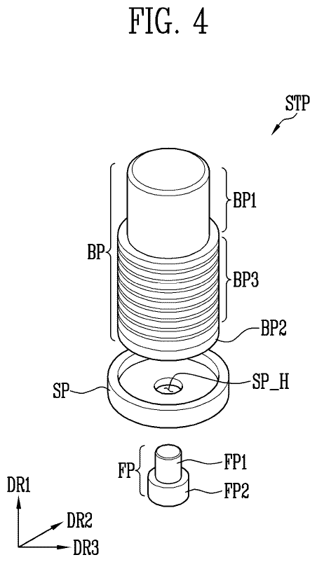

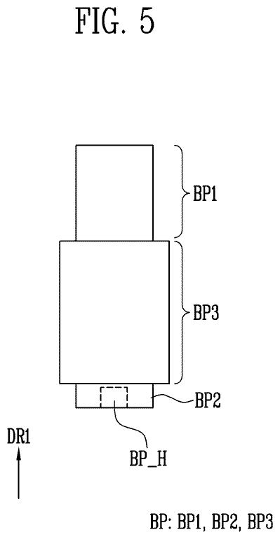

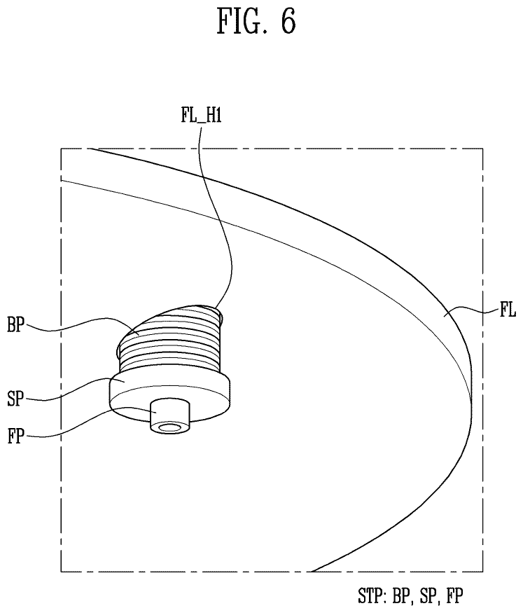

Hereinafter, the stopper STP in accordance with an embodiment will be described with reference to FIGS. 4 to 7. FIG. 4 is a schematic perspective view illustrating the stopper STP in accordance with an embodiment. FIG. 5 is a schematic sectional view of a main body BP of the stopper STP in accordance with an embodiment. FIG. 6 is a schematic perspective view showing insertion of the stopper STP into the first connector hole FL_H1 in accordance with an embodiment. FIG. 7 is a schematic sectional view illustrating the first state and the second state of the stopper STP in accordance with an embodiment. S1 in FIG. 7 represents the first state of the stopper STP1, and S2 represents the second state of the stopper STP.

Referring to FIGS. 4 to 6, an embodiment of the stopper STP may include the main body BP, a support SP, and a fastener FP.

At least a portion of the main body BP may be inserted into the first connector hole FL_H1 and/or a second connector hole FL_H2. The main body BP may have a shape corresponding to the first connector hole FL_H1 and/or the second connector hole FL_H2. In an embodiment, for example, where each of the first connector hole FL_H1 and the second connector hole FL_H2 has a cylindrical shape in a cross-section, the main body BP may also have a cylindrical shape. However, the disclosure is not limited to the aforementioned example. In another embodiment where each of the first connector hole FL_H1 and the second connector hole FL_H2 has a polygonal shape, the main body BP may also have a polygonal shape in a cross-section.

The main body BP may include a first body part BP1, a second body part BP2, and a third body part BP3. The first body part BP1 may be a part positioned on a first end of the main body BP. The first body part BP1 may be a part that protrudes further than the upper surface FL_S of the connector FL when the stopper STP is inserted into the first or second connector hole FL_H1 or FL_H2 such that at least a portion of the stopper STP protrudes further than the upper surface FL_S of the connector FL in a state where the stopper STP is inserted into the first or second connector hole FL_H1 or FL_H2. The second body part BP2 may be a part positioned on a second end of the main body BP that is opposite to the first end. The third body part BP3 may be a part positioned between the first body part BP1 and the second body part BP2.

The third body part BP3 may be tapped to have a first shape, that is, a tapping is performed on the third body part BP3 to have the first shape. In an embodiment, for example, an outer sidewall of the third body part BP3 may be tapped to have the first shape. In an embodiment, for example, the outer sidewall of the third body part BP3 may be tapped to have the first shape, and a thread may be defined or formed on the outer sidewall of the third body part BP3. The first shape may be a threaded shape.

In such an embodiment where the third body part BP3 is tapped, the first connector hole FL_H1 and the second connector hole FL_H2 may be tapped to have a second shape corresponding to the first shape. The tapped shapes of the first connector hole FL_H1 and the second connector hole FL_H2 may correspond to the tapped shape of the third body part BP3. In an embodiment, for example, the first connector hole FL_H1 and the second connector hole FL_H2 may be tapped to have the second shape, and a thread may be formed in each of the first connector hole FL_H1 and the second connector hole FL_H2. The second shape may be a threaded shape. However, the disclosure is not limited to the aforementioned example, and the tapped shapes may vary.

The first connector hole FL_H1 and the second connector hole FL_H2 may be tapped to enable threaded engagement with the third body part BP3. In an embodiment, for example, each of the first connector hole FL_H1 and the second connector hole FL_H2 may have a tapped shape of an internal thread, while the third body part BP3 may have a tapped shape of an external thread, thus allowing the third body part BP3 to threadedly engage with (or coupled, fixed or fastened to) the first connector hole FL_H1 or the second connector hole FL_H2. However, the disclosure is not limited to the aforementioned example.

The first body part BP1 and the second body part BP2 may not be tapped. Since the first body part BP1 and the second body part BP2 are not tapped, the height to which the first body part BP1 (or at least a portion of the main body BP) protrudes further than the upper surface FL_S of the connector FL may be appropriately adjusted, and the stopper STP may be effectively prevented from being undesirably removed or torn during the operation of the articulated robot RB. In a case where the first body part BP1 excessively protrudes further than the upper surface FL_S of the connector FL, the rotation of the first rotating part RT1 may be stopped in an unintended area. In the articulated robot RB in accordance with an embodiment of the disclosure, the first body part BP1 and the second body part BP2 are not tapped, such that the first body part BP1 can be adjusted to protrude by an appropriate distance from the upper surface FL_S of the connector FL.

In an embodiment, as shown in FIG. 5, a body hole BP_H may be defined or formed in the main body BP. The main body BP may be provided with a body hole BP_H. At least a portion of the fastener FP may be removably (or detachably) inserted into the body hole BP_H. At least the portion of the fastener may be fastened (e.g., threaded) into the body hole BP_H.

The support SP may be disposed under the main body BP, and may support the main body BP. The support SP may be provided with a support hole SP_H. In an embodiment, for example, the support SP may have a ring shape with the support hole SP_H in a central portion thereof.

An outer diameter of the support SP may be greater than that of the main body BP, in a plan view or when viewed in the first direction Dr1. In the disclosure, the outer diameter of a component may refer to a diameter of the shape formed by the component in a plan view. In a plan view, the outer diameter of the support SP may be greater than that of each of the first connector hole FL_H1 and the second connector hole FL_H2. Accordingly, the support SP may prevent the third body part BP3 from being excessively inserted into the first connector hole FL_H1 or the second connector hole FL_H2. In an embodiment, for example, the third body part BP3 (or the main body BP) may be inserted into the first connector hole FL_H1 or the second connector hole FL_H2 in the first direction DR1 only until the support SP comes into contact with the connector FL.

At least a portion of the fastener FP may be removably (or detachably) inserted into the support hole SP_H and the body hole BP_H. The fastener FP may include a first fastening part FP1 and a second fastening part FP2. The first fastening part FP1 may be removably (or detachably) inserted into the support hole SP_H and the body hole BP_H.

A shape of the first fastening part FP1 may correspond to that of each of the support hole SP_H and the body hole BP_H. In an embodiment, for example, where each of the support hole SP_H and the body hole BP_H has a cylindrical shape, the first fastening part FP1 may have a cylindrical shape in a cross-section. However, the disclosure is not limited to the aforementioned example. In another embodiment, where each of the support hole SP_H and the body hole BP_H has a polygonal shape, the first fastening part FP1 may have a polygonal shape in a cross-section.

In a plan view, an outer diameter of the first fastening part FP1 may be less than that of the second fastening part FP2. In a plan view, the outer diameter of the second fastening part FP2 may be greater than that of each of the support hole SP_H and the body hole BP_H. Accordingly, the second fastening part FP2 may not be inserted into the support hole SP_H and the body hole BP_H, and the fastener FP may fix the support SP to the main body BP.

Referring to FIG. 7, in the first state S1, the main body BP may not protrude further in the first direction DR1 from the upper surface FL_S of the connector FL. The first state S1 may refer to a state in which the stopper STP does not stop the rotation of the first rotating part RT1.

In the first state S1, the first body part BP1 may not protrude further in the first direction DR1 from the upper surface FL_S of the connector FL. In the first state S1, the first body part BP1 may be inserted into and remain in the first connector hole FL_H1 and/or the second connector hole FL_H2. In an embodiment, for example, in the first state S1, the first body part BP1 may be positioned in the first connector hole FL_H1 and/or the second connector hole FL_H2.

In the first state S1, at least a portion of the third body part BP3 may be inserted into and remain in the first connector hole FL_H1 and/or the second connector hole FL_H2. In the first state S1, at least the portion of the third body part BP3 may be fastened (e.g., threaded) into the first connector hole FL_H1 and/or the second connector hole FL_H2.

In the second state S2, the main body BP may protrude further in the first direction DR1 from the upper surface FL_S of the connector FL. The second state S2 may refer to a state in which the stopper STP stops the rotation of the first rotating part RT1. In the second state S2, a portion of the first rotating part RT1 may come into contact with at least a portion of the main body BP that protrudes further in the first direction DR1 from the upper surface FL_S of the connector FL, such that the rotation of the first rotating part RT1 may be stopped by the main body BP. In the second state S2, the first body part BP1 may protrude further in the first direction DR1 from the upper surface FL_S of the connector FL.

In the second state S2, at least a portion of the third body part BP3 may be inserted into and remain in the first connector hole FL_H1 and/or the second connector hole FL_H2. In the second state S2, the third body part BP3 may be inserted further into the first connector hole FL_H1 and/or the second connector hole FL_H2 compared to the position of the third body part BP3 in the first state S1. In an embodiment, for example, in the second state S2, a surface area with which the third body part BP3 contacts the first connector hole FL_H1 and/or the second connector hole FL_H2 may be greater than a surface area with the third body part BP3 in the first state S1 contacts the first connector hole FL_H1 and/or the second connector hole FL_H2. In the second state S2, at least the portion of the third body part BP3 may be fastened (e.g., threaded) into the first connector hole FL_H1 and/or the second connector hole FL_H2.

In the first state S1 and the second state S2, the support SP may not be inserted into the first connector hole FL_H1 and/or the second connector hole FL_H2. Until the support SP contacts the connector FL, the third body part BP3 (or the main body BP) may be inserted into the first connector hole FL_H1 and/or the second connector hole FL_H2, and the height to which the first body part BP1 protrudes further in the first direction DR1 from the upper surface FL_S of the connector FL may be adjusted.

In an embodiment, the stopper STP disposed in the first connector hole FL_H1 may be selectively in the first state S1, while the stopper STP disposed in the second connector hole FL_H2 may is in the second state S2. In such an embodiment, the stopper STP disposed in the first connector hole FL_H1 may be selectively in the second state S2, while the stopper STP disposed in the second connector hole FL_H2 may is in the first state S1. In such an embodiment, the stoppers STP that are respectively disposed in the first connection hole FL_H1 and the second connection hole FL_H2 may be in a same state.

The stopper STP according to an embodiment of the disclosure is configured in a way such that the operational state of the stopper STP can be easily controlled or changed by adjusting the position of the third body part BP3. The rotational range and the rotational radius of the rotating parts RT1 and RT2 may be easily controlled by adjusting the operational state of the stopper STP. As a result, adjustment of the rotational range and the rotational radius of the rotating parts RT1 and RT2 may be performed without any additional modifications to the articulated robot RB, thereby leading to a reduction in processing costs.

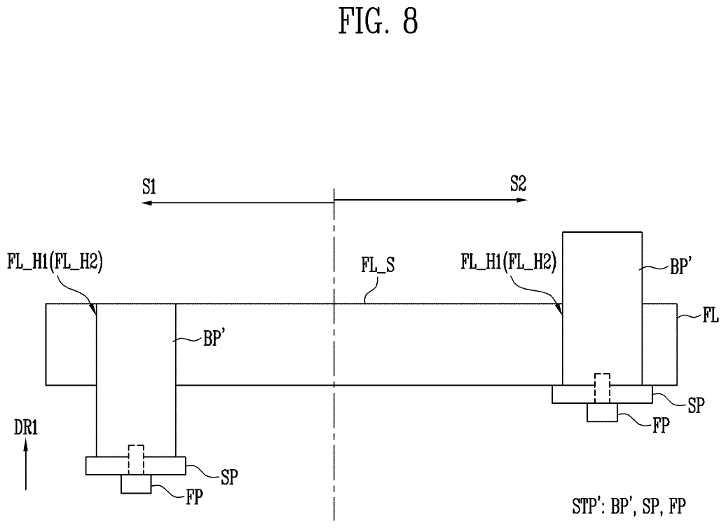

Hereinafter, a stopper STP′ in accordance with another embodiment will be described with reference to FIG. 8. FIG. 8 is a schematic sectional view illustrating the first state and the second state of the stopper STP′ in accordance with an embodiment. The stopper STP′ shown in FIG. 8 is substantially the same as the stopper STP shown in FIGS. 4 to 6 except that a main body BP′ does not include a tapped portion.

In an embodiment, as shown in FIG. 8, the main body BP′ may not include a tapped portion, that is, no portion of the main body BP′ has a threaded shape. In an embodiment, the main body BP′ may be configured to move along an inner surface of the first connector hole FL_H1 and/or the second connector hole FL_H2 when pressure is applied thereto. In an embodiment, for example, the main body BP′ may be configured to move along the inner surface of the first connector hole FL_H1 and/or the second connector hole FL_H2 using pneumatic pressure. In an embodiment, for example, the main body BP′ may slide along the inner surface of the first connector hole FL_H1 and/or the second connector hole FL_H2 when pressure is applied thereto.

In an embodiment, for example, in the first state S1, the main body BP′ may not protrude further in the first direction DR1 from the upper surface FL_S of the connector FL. When pressure is applied to the main body BP′ in the first state S1, the main body BP′ may slide thereby being in the second state S2 in which the main body BP′ protrudes further in the first direction DR1 from the upper surface FL_S of the connector FL. In the second state S2, when pressure is applied to the main body BP′, the main body BP′ may slide, thereby being in the first state S1.

In an embodiment, the main body BP′ may be configured to move along an inner surface of the first connector hole FL_H1 and/or the second connector hole FL_H2 when an electrical signal is applied thereto. In an embodiment, for example, the main body BP′ may include an electromagnet, and may be configured to become magnetized and move along the inner surface when an electrical signal is applied thereto. In an embodiment, for example, the main body BP′ may slide along the inner surface of the first connector hole FL_H1 and/or the second connector hole FL_H2 when an electrical signal is applied thereto.

In an embodiment, for example, in the first state S1, the main body BP′ may not protrude further in the first direction DR1 from the upper surface FL_S of the connector FL. When an electrical signal is applied to the main body BP′ in the first state S1, the main body BP′ may slide, entering the second state S2 in which the main body BP′ protrudes further in the first direction DR1 from the upper surface FL_S of the connector FL. In the second state S2, when an electrical signal is applied to the main body BP′, the main body BP′ may slide, thus entering the first state S1.

The stopper STP′ according to an embodiment is also configured so that the operational state of the stopper STP′ can be easily controlled by adjusting the position of the main body BP′. The rotational range and the rotational radius of the rotating parts RT1 and RT2 may be easily controlled by adjusting the operational state of the stopper STP′. As a result, adjustment of the rotational range and the rotational radius of the rotating parts RT1 and RT2 may be performed without any additional modifications to the articulated robot RB, thereby leading to a reduction in processing costs.

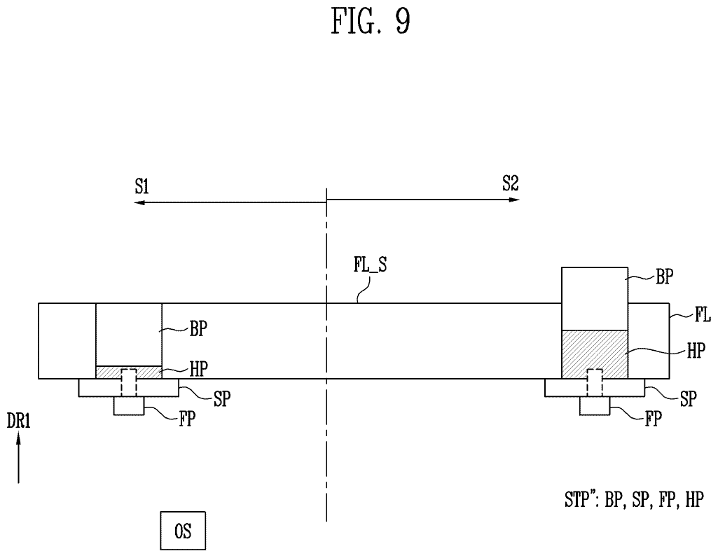

Hereinafter, a stopper STP″ in accordance with another embodiment will be described with reference to FIG. 9. FIG. 9 is a schematic sectional view illustrating the first state and the second state of the stopper STP″ in accordance with an embodiment. The stopper STP″ shown in FIG. 9 is substantially the same as stopper STP shown in FIGS. 4 to 6 except that the stopper STP″ further includes a movable part HP.

The stopper STP″ may further include the movable part HP. The movable part HP may be disposed adjacent to the main body BP. The movable part HP may be disposed under the main body BP. However, the disclosure is not limited to those described above. The position of the movable part HP may be changed in various ways.

The movable part HP may vary in height. The movable part HP may be a component capable of height adjustment. In an embodiment, for example, the movable part HP may include at least one selected from a spring, a cylinder, and a worm gear. The movable part HP may be a height adjusting component, which is disposed adjacent to the main body BP to adjust the height of the main body BP.

The main body BP may have a same configuration as the main body BP described with reference to FIGS. 4 to 7. Alternatively, in an embodiment, the main body BP may have the same configuration as the main body BP′ described with reference to FIG. 8. Alternatively, in an embodiment, the main body BP may be a pillar-shaped component that is not tapped or is not configured to slide in response to application of pressure or an electrical signal.

In the first state S1, the main body BP may be inserted into and remain in the first connector hole FL_H1 or the second connector hole FL_H2. The main body BP may not protrude further in the first direction DR1 from the upper surface FL_S of the connector FL. From the foregoing state, the height of the movable part HP may vary, thus allowing the stopper STP″ to be in the second state S2 in which the main body BP protrudes further in the first direction DR1 from the upper surface FL_S of the connector FL.

The stopper STP″ according to an embodiment is also configured in a way such that the operational state of the stopper STP″ can be easily controlled by adjusting the position of the main body BP. The rotational range and the rotational radius of the rotating parts RT1 and RT2 may be easily controlled by adjusting the operational state of the stopper STP″. As a result, adjustment of the rotational range and the rotational radius of the rotating parts RT1 and RT2 may be performed without any additional modifications to the articulated robot RB, thereby leading to a reduction in processing costs.

In an embodiment, the articulated robot RB may further include an optical sensor (e.g., OS in FIG. 9) disposed either over or under the stopper STP, STP′, or STP″. FIG. 9 shows an embodiment where the optical sensor OS disposed under the stopper STP″ as an example, but not being limited thereto. In another embodiment, the optical sensor OS disposed over or above the stopper the stopper STP″. Although not shown, embodiments of the articulated robot RB shown in FIGS. 7 and 8 may further the optical sensor OS disposed either over or under the stopper STP or STP′. The optical sensor OS may sense a movement (or changed positions) of the stopper STP, STP′, or STP″. In an embodiment, for example, the optical sensor OS may sense a movement of the stopper STP, STP′, or STP″ in the first direction DR1. In an embodiment, for example, the optical sensor OS may be disposed over the stopper STP, STP′, or STP″ to sense a distance between the optical sensor and the stopper STP, STP′, or STP″, thereby detecting whether the stopper STP, STP′, or STP″ moves toward or away from the optical sensor. Alternatively, the optical sensor may be disposed under the stopper STP, STP′, or STP″ to sense a distance between the optical sensor and the stopper STP, STP′, or STP″, thereby detecting whether the stopper STP, STP′, or STP″ moves toward or away from the optical sensor.

In an embodiment, the articulated robot RB that further includes the optical sensor OS may easily sense the operational state of the stopper STP, STP′, or STP″.

Embodiments of the disclosure may provide an articulated robot in which a stopper can be easily attached and detached to allow position of the stopper to be easily adjusted, thereby enabling adjustment in rotational radius of a rotating part.

Embodiments of the disclosure may provide an articulated robot in which the position of the stopper can be easily adjusted without disassembling the robot.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. An articulated robot, comprising:
a first rotating part;
a second rotating part rotatably connected to the first rotating part;
a connector connecting the first rotating part and the second rotating part, wherein a first connector hole and a second connector hole are defined through the connector; and
a stopper including a portion detachably inserted into each of the first connector hole and the second connector hole,
wherein the stopper comprises:
a main body including the portion inserted into each of the first connector hole and the second connector hole;
a support disposed under the main body, wherein a support hole is defined through the support; and
a fastener including a portion detachably inserted into the support hole.

2. The articulated robot according to claim 1, wherein the stopper is in a first state in which the main body does not protrude further than an upper surface of the connector or in a second state in which the main body protrudes further in a first direction than the upper surface of the connector.

3. The articulated robot according to claim 1, wherein the main body comprises:
a first body part positioned on a first end;
a second body part positioned on a second end; and
a third body part positioned between the first body part and the second body part,
wherein the third body part has a first shape.

4. The articulated robot according to claim 3,
wherein each of the first connector hole and the second connector hole has a second shape corresponding to the first shape, and
wherein the third body part is detachably fastened into each of the first connector hole and the second connector hole.

5. The articulated robot according to claim 4, wherein each of the first shape and the second shape corresponds to a threaded shape.

6. The articulated robot according to claim 1,
wherein the main body includes a body hole, and
wherein the fastener includes a portion detachably inserted into the body hole.

7. The articulated robot according to claim 1, wherein the support has an outer diameter greater than an outer diameter of the main body, in a plan view.

8. The articulated robot according to claim 1,
wherein the fastener comprises a first fastening part and a second fastening part,
wherein the first fastening part has an outer diameter less than an outer diameter of the second fastening part, in a plan view, and
wherein the second fastening part is not inserted into the support hole.

9. The articulated robot according to claim 1, wherein the main body moves along an inner surface of each of the first connector hole and the second connector hole when a pressure or an electrical signal is applied thereto.

10. The articulated robot according to claim 1,
wherein the stopper further comprises a movable part disposed adjacent to the main body, and
wherein the movable part comprises at least one selected from a spring, a cylinder, and a worm gear.

11. The articulated robot according to claim 1, further comprising an optical sensor disposed over or under the stopper,
wherein the optical sensor senses a movement of the stopper.

12. An articulated robot, comprising:
a first rotating part;
a second rotating part rotatably connected to the first rotating part;
a connector connecting the first rotating part and the second rotating part, wherein a first connector hole and a second connector hole are defined in the connector; and
a stopper including a portion detachably inserted into each of the first connector hole and the second connector hole,
wherein the stopper comprises a main body including the portion inserted into each of the first connector hole and the second connector hole,
wherein the stopper is in a first state in which the main body does not protrude further than an upper surface of the connector or in a second state in which the main body protrudes further in a first direction than the upper surface of the connector.

13. The articulated robot according to claim 12, wherein the main body comprises:
a first body part positioned on a first end;
a second body part positioned on a second end; and
a third body part positioned between the first body part and the second body part,
wherein the third body part has a first shape.

14. The articulated robot according to claim 13,
wherein the first direction corresponds to a direction perpendicular to a plane on which the articulated robot is disposed,
wherein each of the first connector hole and the second connector hole has a second shape corresponding to the first shape, and
wherein the third body part is detachably fastened into each of the first connector hole and the second connector hole.

15. The articulated robot according to claim 13,
wherein the third body part includes a portion inserted into the first connector hole or the second connector hole in each of the first state and the second state, and
wherein a surface area with which the third body part in the second state contacts each of the first connector hole and the second connector hole is greater than a surface area with which the third body part in the first state contacts each of the first connector hole and the second connector hole.

16. The articulated robot according to claim 12, wherein the main body moves along an inner surface of each of the first connector hole and the second connector hole when a pressure or an electrical signal is applied thereto.

17. The articulated robot according to claim 12,
wherein the stopper further comprises a movable part disposed adjacent to the main body, and
wherein the movable part comprises at least one selected from a spring, a cylinder, and a worm gear.

18. The articulated robot according to claim 12,
wherein the stopper further comprises a support disposed under the main body, wherein a support hole is defined in the support,
wherein the support has an outer diameter greater than an outer diameter of the main body, in a plan view, and
wherein the main body is inserted into the first connector hole and the second connector hole until the support contacts the connector.

19. The articulated robot according to claim 18,
wherein the stopper further comprises a fastener including a portion detachably inserted into the support hole,
wherein the fastener comprises a first fastening part and a second fastening part,
wherein the first fastening part has an outer diameter less than an outer diameter of the second fastening part, in a plan view, and
wherein the second fastening part is not inserted into the support hole.

20. The articulated robot according to claim 12, further comprising an optical sensor disposed over or under the stopper,
wherein the optical sensor senses a movement of the stopper.
